(19) United States
(12) Patent Application Publication
(10) Pub. No.: US 2026/0273729 A1
(43) Pub. Date: Sep. 17, 2026

(54) ROBOTIC ACTUATOR

(71) Applicant: Apptronik, Inc., Austin, TX (US)

(72) Inventors: Bradley Aaron Resh, Austin, TX (US); James Cornelius Cobau, Austin, TX (US)

(21) Appl. No.: 19/566,732

(22) Filed: Mar. 13, 2026

Related U.S. Application Data
(60) Provisional application No. 63/771,237, filed on Mar. 13, 2025.

(51) Int. Cl. B25J 9/10; B25J 13/08; B25J 19/00; B62D 57/032

(52) U.S. Cl. CPC B25J 9/102; B25J 13/088; B25J 19/0041; B62D 57/032

(57) ABSTRACT

A robotic actuator includes a mechanical ground; a motor coupled to the mechanical ground, the motor including a stator and a rotor; a gearbox; and an actuator output. The gearbox include a shaft that extends through the gearbox and includes a hollow bore; a first plurality of first planet gears; at least one sun gear that rides on the shaft and is rotationally coupled to the rotor, the at least one sun gear configured to transmit torque produced by the rotor of the motor to the first planet gears; a second plurality of second planet gears; a first ring gear coupled to the first planet gears; and a second ring gear coupled to the second planet gears. The actuator output is coupled to an output of the gearbox.

### CROSS-REFERENCE TO RELATED APPLICATIONS

This patent application claims the benefit under 35 U.S.C. § 119(e) of U.S. Provisional Patent Application No. 63/771,237, entitled “Robotic Actuator” and filed on Mar. 13, 2025, the contents of which are incorporated herein by reference in their entirety.

### TECHNICAL FIELD

The present disclosure describes example implementations of a robotic actuator and, more particularly, a robotic actuator for robotic systems, such as humanoid robots.

### BACKGROUND

Robots use actuators to move around. Electric actuators are typically composed of an electric motor to convert electrical energy into high-speed, low-torque energy, and a gearbox to convert high-speed, low-torque energy into high-torque, low-speed energy.

### SUMMARY

In an example implementation, a robotic actuator includes a mechanical ground; a motor coupled to the mechanical ground, the motor including a stator and a rotor; a gearbox; and an actuator output. The gearbox include a shaft that extends through the gearbox and includes a hollow bore; a first plurality of first planet gears; at least one sun gear that rides on the shaft and is rotationally coupled to the rotor, the at least one sun gear configured to transmit torque produced by the rotor of the motor to the first planet gears; a second plurality of second planet gears; a first ring gear coupled to the first planet gears; and a second ring gear coupled to the second planet gears. The actuator output is coupled to an output of the gearbox.

In an aspect combinable with the example implementation, the hollow bore extends through an entire longitudinal length of the shaft, and is adapted to provide passage of a wire component at least partially through the robotic actuator.

In another aspect combinable with one, some, or all of the previous aspects, a diameter of the hollow bore is smaller than a diameter of the at least one sun gear.

In another aspect combinable with one, some, or all of the previous aspects, the shaft includes a slip ring disposed in the hollow bore and configured to transmit power or signal to the robotic actuator.

Another aspect combinable with one, some, or all of the previous aspects includes a support shaft disposed at least partially within the hollow bore of the shaft of the gearbox, the support shaft having a second hollow bore extending at least partially through the shaft of the gearbox.

In another aspect combinable with one, some, or all of the previous aspects, the support shaft is coupled to the mechanical ground.

In another aspect combinable with one, some, or all of the previous aspects, the support shaft is fixedly mounted to the mechanical ground.

In another aspect combinable with one, some, or all of the previous aspects, the support shaft is coupled to the shaft of the gearbox with at least one bearing.

In another aspect combinable with one, some, or all of the previous aspects, the second planet gears are coaxially aligned with and rotationally coupled to the first planet gears.

In another aspect combinable with one, some, or all of the previous aspects, each first planet gear is coaxially coupled to a respective second planet gear to form a planet gear pair.

In another aspect combinable with one, some, or all of the previous aspects, each first planet gear has a larger diameter than each second planet gear.

In another aspect combinable with one, some, or all of the previous aspects, the first ring gear includes a first radial center, and the second ring gear includes a second radial center.

In another aspect combinable with one, some, or all of the previous aspects, the first and second radial centers are aligned on a common axis of rotation.

In another aspect combinable with one, some, or all of the previous aspects, the at least one sun gear includes a third radial center that is aligned on the common axis of rotation.

In another aspect combinable with one, some, or all of the previous aspects, the first ring gear includes a first diameter, and the second ring gear includes a second diameter different from the first diameter.

In another aspect combinable with one, some, or all of the previous aspects, the second diameter is larger than the first diameter.

In another aspect combinable with one, some, or all of the previous aspects, the gearbox has a gear ratio between 10:1 and 100:1.

In another aspect combinable with one, some, or all of the previous aspects, a ratio of a power of the motor to a radial dimension of the robotic actuator is between 1 RMS Watts/mm to 20 RMS Watts/mm.

In another aspect combinable with one, some, or all of the previous aspects, the radial dimension corresponds to a radius of a front surface of the mechanical ground.

In another aspect combinable with one, some, or all of the previous aspects, a power rating of the motor is between 100 RMS Watts and 1000 RMS Watts.

In another aspect combinable with one, some, or all of the previous aspects, the robotic actuator is configured to generate an amount of torque between 20 RMS Nm and 200 RMS Nm.

In another aspect combinable with one, some, or all of the previous aspects, a backlash between the mechanical ground and the actuator output is between 6 arc minute and 50 ar cminute.

In another aspect combinable with one, some, or all of the previous aspects, the robotic actuator is configured to generate a reflected inertia between 0.01 kg·m2 and 1.00 kg·m2.

In another aspect combinable with one, some, or all of the previous aspects, a ratio of an axial dimension of the robotic actuator to a radial dimension of the robotic actuator is between 0.1 and 5.0.

In another aspect combinable with one, some, or all of the previous aspects, the axial dimension corresponds to a distance between a rear surface of the mechanical ground and a front surface of the actuator output.

In another aspect combinable with one, some, or all of the previous aspects, at least one of the motor or the gearbox is circumferentially surrounded by the mechanical ground.

Another aspect combinable with one, some, or all of the previous aspects includes a planet carrier coupled to the mechanical ground and configured to support the first planet gears and the second planet gears.

In another aspect combinable with one, some, or all of the previous aspects, the planet carrier is coupled to the mechanical ground by at least one bearing.

In another aspect combinable with one, some, or all of the previous aspects, the motor, gearbox and planet carrier are circumferentially surrounded by the mechanical ground.

In another aspect combinable with one, some, or all of the previous aspects, the motor includes the stator coupled to the mechanical ground and configured to generate a magnetic field; and the rotor configured to generate the torque based on interaction between the rotor and the magnetic field.

Another aspect combinable with one, some, or all of the previous aspects includes a sensor configured to detect commutation of the motor.

In another aspect combinable with one, some, or all of the previous aspects, the sensor includes an incremental rotary encoder.

In another aspect combinable with one, some, or all of the previous aspects, the sensor includes a ring magnet mounted to the motor; and a read head coupled to the mechanical ground and configured to detect a magnetic field generated by the ring magnet.

Another aspect combinable with one, some, or all of the previous aspects includes a second sensor configured to detect an amount of output of the robotic actuator.

In another aspect combinable with one, some, or all of the previous aspects, the second sensor includes a second magnet coupled to the actuator output; and a second read head coupled to the mechanical ground and configured to detect a magnetic field generated by the second magnet.

In another aspect combinable with one, some, or all of the previous aspects, the second read head generates a signal indicating angular displacement of the second magnet relative to the mechanical ground.

In another aspect combinable with one, some, or all of the previous aspects, the output of the gearbox includes the second ring gear.

In another aspect combinable with one, some, or all of the previous aspects, the actuator output is rotationally fixed to the second ring gear.

In another example implementation, a humanoid robot includes at least one robotic limb; and an actuator configured to move at least a portion of the at least one robotic limb. The actuator includes a mechanical ground; a motor coupled to the mechanical ground, the motor including a stator and a rotor; and a gearbox. The gearbox includes a shaft that extends through the gearbox and includes a hollow bore; a first plurality of first planet gears; at least one sun gear that rides on the shaft and is rotationally coupled to the rotor, the at least one sun gear configured to transmit torque produced by the rotor to the first planet gears; a second plurality of second planet gears; a first ring gear coupled to the first planet gears; and a second ring gear coupled to the second planet gears. The gearbox includes an actuator output coupled to an output of the gearbox.

In an aspect combinable with the example implementation, the hollow bore extends through an entire longitudinal length of the shaft, and the hollow bore is adapted to provide passage of a wire component at least partially through the robotic actuator.

In another aspect combinable with one, some, or all of the previous aspects, a diameter of the hollow bore is smaller than a diameter of the at least one sun gear.

In another aspect combinable with one, some, or all of the previous aspects, the shaft includes a slip ring disposed in the hollow bore and configured to transmit power or signal to the robotic actuator.

Another aspect combinable with one, some, or all of the previous aspects includes a support shaft disposed at least partially within the hollow bore of the shaft of the gearbox, the support shaft having a second hollow bore extending at least partially through the shaft of the gearbox.

In another aspect combinable with one, some, or all of the previous aspects, the support shaft is coupled to the mechanical ground.

In another aspect combinable with one, some, or all of the previous aspects, the support shaft is fixedly mounted to the mechanical ground.

In another aspect combinable with one, some, or all of the previous aspects, the support shaft is coupled to the shaft of the gearbox with at least one bearing.

In another aspect combinable with one, some, or all of the previous aspects, the second planet gears are coaxially aligned with and rotationally coupled to the first planet gears.

In another aspect combinable with one, some, or all of the previous aspects, each first planet gear is coaxially coupled to a respective second planet gear to form a planet gear pair.

In another aspect combinable with one, some, or all of the previous aspects, each first planet gear has a larger diameter than each second planet gear.

In another aspect combinable with one, some, or all of the previous aspects, the first ring gear includes a first radial center, and the second ring gear includes a second radial center.

In another aspect combinable with one, some, or all of the previous aspects, the first and second radial centers are aligned on a common axis of rotation.

In another aspect combinable with one, some, or all of the previous aspects, the at least one sun gear includes a third radial center that is aligned on the common axis of rotation.

In another aspect combinable with one, some, or all of the previous aspects, the first ring gear includes a first diameter, and the second ring gear includes a second diameter different from the first diameter.

In another aspect combinable with one, some, or all of the previous aspects, the second diameter is larger than the first diameter.

In another aspect combinable with one, some, or all of the previous aspects, the at least one robotic limb is a robotic leg.

In another aspect combinable with one, some, or all of the previous aspects, the humanoid robot includes a hip joint assembly; and the actuator is configured to adjust the respective hip joint assembly in two degrees of hip freedom through differential linear actuation.

In another aspect combinable with one, some, or all of the previous aspects, the actuator has a gear ratio between 10:1 and 25:1.

In another aspect combinable with one, some, or all of the previous aspects, the actuator is configured to generate an amount of torque between 20 RMS Nm and 200 RMS Nm.

In another aspect combinable with one, some, or all of the previous aspects, the actuator is configured to generate a reflected inertia between 0.01 kg·m2 and 1.00 kg·m2.

In another aspect combinable with one, some, or all of the previous aspects, a ratio of an axial dimension of the actuator to a radial dimension of the actuator is between 0.1 and 5.0.

In another aspect combinable with one, some, or all of the previous aspects, the axial dimension corresponds to a distance between a rear surface of the mechanical ground of the actuator and a front surface of an output of the actuator.

In another aspect combinable with one, some, or all of the previous aspects, a backlash between the first planet gears and the second planet gears is between 6 arc minute and 12 arc minute.

Another aspect combinable with one, some, or all of the previous aspects includes a planet carrier configured to support the first planet gears and the second planet gears.

In another aspect combinable with one, some, or all of the previous aspects, a ratio of a power of the motor to a radial dimension of the actuator is between 1 RMS Watts/mm to 20 RMS Watts/mm.

In another aspect combinable with one, some, or all of the previous aspects, the radial dimension corresponds to a radius of a front surface of the mechanical ground.

In another aspect combinable with one, some, or all of the previous aspects, a backlash between the mechanical ground and the actuator output is between 6 arc minute and 50 arc minute.

In another aspect combinable with one, some, or all of the previous aspects, a power rating of the motor is between 100 RMS Watts and 1000 RMS Watts.

In another aspect combinable with one, some, or all of the previous aspects, at least one of the motor or the gearbox is circumferentially surrounded by the mechanical ground.

In another aspect combinable with one, some, or all of the previous aspects, the motor includes the stator coupled to the mechanical ground and configured to generate a magnetic field; and the rotor configured to generate torque based on interaction between the rotor and the magnetic field.

Another aspect combinable with one, some, or all of the previous aspects includes a sensor configured to detect commutation of the motor.

In another aspect combinable with one, some, or all of the previous aspects, the sensor includes an incremental rotary encoder.

In another aspect combinable with one, some, or all of the previous aspects, the sensor includes a ring magnet mounted to the motor; and a read head coupled to the mechanical ground and configured to detect a magnetic field generated by the ring magnet.

Another aspect combinable with one, some, or all of the previous aspects includes a second sensor configured to detect an amount of output of the actuator.

In another aspect combinable with one, some, or all of the previous aspects, the second sensor includes a second magnet coupled to the actuator output; and a second read head coupled to the mechanical ground and configured to detect a magnetic field generated by the second magnet.

In another aspect combinable with one, some, or all of the previous aspects, the second read head generates a signal indicating angular displacement of the second magnet relative to the mechanical ground.

In another aspect combinable with one, some, or all of the previous aspects, the output of the gearbox includes the second ring gear.

In another aspect combinable with one, some, or all of the previous aspects, the actuator output is rotationally fixed to the second ring gear.

In another aspect combinable with one, some, or all of the previous aspects, the actuator is one of a plurality of actuators.

Another aspect combinable with one, some, or all of the previous aspects includes a trunk, at least one upper body appendage including the at least one robotic limb, and at least one lower body appendage, wherein each appendage of the at least one upper body appendage and the at least one lower body appendage includes a respective actuator of the plurality of actuators.

Another aspect combinable with one, some, or all of the previous aspects includes a torso joint coupling a torso of the humanoid robot to the trunk, the torso joint including a torso actuator of the plurality of actuators.

Another aspect combinable with one, some, or all of the previous aspects includes a first hip joint coupling the trunk to a first lower body appendage of the at least one lower body appendage, the first hip joint including a first hip actuator of the plurality of actuators; and a second hip joint coupling the trunk to a second lower body appendage of the at least one lower body appendage, the second hip joint including a second hip actuator of the plurality of actuators.

Another aspect combinable with one, some, or all of the previous aspects includes a first knee joint coupling a first upper portion of the first lower body appendage to a first lower portion of the first lower body appendage, the first knee joint including a first knee actuator of the plurality of actuators; and a second knee joint coupling a second upper portion of the second lower body appendage to a second lower portion of the second lower body appendage, the second knee joint including a second knee actuator of the plurality of actuators.

Another aspect combinable with one, some, or all of the previous aspects includes a first shoulder joint coupling the trunk to a first upper body appendage of the at least one upper body appendage, the first shoulder joint including a first shoulder actuator of the plurality of actuators; and a second shoulder joint coupling the trunk to a second upper body appendage of the at least one upper body appendage, the second shoulder joint including a second shoulder actuator of the plurality of actuators.

Another aspect combinable with one, some, or all of the previous aspects includes a first elbow joint coupling a first upper portion of the first upper body appendage to a first lower portion of the first upper body appendage, the first elbow joint including a first elbow actuator of the plurality of actuators; and a second elbow joint coupling a second upper portion of the second upper body appendage to a second lower portion of the second upper body appendage, the second elbow joint including a second elbow actuator of the plurality of actuators.

Another aspect combinable with one, some, or all of the previous aspects includes a plurality of joints supporting the trunk, the at least one upper body appendage, and the at least one lower body appendage, wherein the plurality of actuators include actuators of varying sizes, and each joint of the plurality of joints includes at least one actuator of the plurality of actuators.

In another aspect combinable with one, some, or all of the previous aspects, at least one joint of the plurality of joints includes a first actuator and a second actuator of the plurality of actuators.

In another aspect combinable with one, some, or all of the previous aspects, the first actuator and the second actuator are different.

In another example implementation, a method of operating a humanoid robot includes operating an actuator. The actuator includes a mechanical ground; a motor coupled to the mechanical ground, the motor including a stator and a rotor; a gearbox that includes a shaft that extends through the gearbox and includes a hollow bore; a first plurality of first planet gears; at least one sun gear that rides on the shaft and is rotationally coupled to the rotor, the at least one sun gear configured to transmit torque produced by the rotor of the motor to the first planet gears; a second plurality of second planet gears; a first ring gear coupled to the first planet gears; and second ring gear coupled to the second planet gears; and an actuator output coupled to an output of the gearbox. The method includes, during operation, transmitting torque produced by the motor to the gearbox; and based on the torque transmitted to the gearbox, causing movement of at least a portion of a robotic limb coupled to the actuator output.

In an aspect combinable with the example implementation, the second planet gears are coaxially aligned with and rotationally coupled to the first planet gears.

In another aspect combinable with one, some, or all of the previous aspects, each first planet gear is coaxially coupled to a respective second planet gear to form a planet gear pair.

In another aspect combinable with one, some, or all of the previous aspects, each first planet gear has a larger diameter than each second planet gear.

In another aspect combinable with one, some, or all of the previous aspects, the first ring gear includes a first radial center, and the second ring gear includes a second radial center.

In another aspect combinable with one, some, or all of the previous aspects, the first and second radial centers are aligned on a common axis of rotation.

In another aspect combinable with one, some, or all of the previous aspects, the at least one sun gear includes a third radial center that is aligned on the common axis of rotation.

In another aspect combinable with one, some, or all of the previous aspects, the first ring gear includes a first diameter, and the second ring gear includes a second diameter different from the first diameter.

In another aspect combinable with one, some, or all of the previous aspects, the second diameter is larger than the first diameter.

In another aspect combinable with one, some, or all of the previous aspects, the robotic limb includes a robotic leg.

In another aspect combinable with one, some, or all of the previous aspects, causing movement of the robotic limb coupled to the actuator output includes controlling adjusting a hip joint assembly in two degrees of hip freedom through differential linear actuation.

In another aspect combinable with one, some, or all of the previous aspects, the gearbox has a gear ratio between 10:1 and 25:1.

In another aspect combinable with one, some, or all of the previous aspects, transmitting torque produced by the motor to the gearbox causes the actuator to generate an amount of torque between 20 RMS Nm and 200 RMS Nm.

In another aspect combinable with one, some, or all of the previous aspects, at least one of the motor or the gearbox is circumferentially surrounded by the mechanical ground.

In another aspect combinable with one, some, or all of the previous aspects, the actuator includes a planet carrier configured to support the first planet gears and the second planet gears.

Another aspect combinable with one, some, or all of the previous aspects includes measuring an amount of output of the actuator using a sensor that includes a magnet coupled to the actuator output; and a read head coupled to the mechanical ground and configured to detect a magnetic field generated by the magnet.

In another aspect combinable with one, some, or all of the previous aspects, measuring the amount of output of the actuator includes receiving, from the read head, a signal indicating angular displacement of the magnet relative to the mechanical ground.

Another aspect combinable with one, some, or all of the previous aspects includes detecting commutation of the motor using a sensor that includes a ring magnet mounted to the motor; and a read head coupled to the mechanical ground and configured to detect a magnetic field generated by the ring magnet.

In another aspect combinable with one, some, or all of the previous aspects, the output of the gearbox includes the second ring gear.

In another aspect combinable with one, some, or all of the previous aspects, the actuator output is rotationally fixed to the second ring gear.

Another aspect combinable with one, some, or all of the previous aspects includes a support shaft disposed at least partially within the hollow bore of the shaft of the gearbox, the support shaft having a second hollow bore extending at least partially through the shaft of the gearbox.

In another aspect combinable with one, some, or all of the previous aspects, the support shaft is coupled to the mechanical ground.

In another aspect combinable with one, some, or all of the previous aspects, the support shaft is fixedly mounted to the mechanical ground.

In another aspect combinable with one, some, or all of the previous aspects, the support shaft is coupled to the shaft of the gearbox with at least one bearing.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIGS. 1-5 are schematic illustrations of an example implementation of a gearbox for a robotic actuator according to the present disclosure.

FIG. 6 is an exploded view of the example implementation of the gearbox of FIGS. 1-5 according to the present disclosure.

FIG. 7 is a schematic illustration of an example implementation of a motor for a robotic actuator that can include the gearbox of FIGS. 1-6 according to the present disclosure.

FIG. 8 is a perspective view of an example robotic actuator according to the present disclosure.

FIG. 9 is a cross-sectional side view of the example robotic actuator of FIG. 8 according to the present disclosure.

FIG. 10 is a schematic illustration of a humanoid robot that includes at least one robotic actuator according to the present disclosure.

FIG. 11 is a schematic, cross-sectional side view of an example robotic actuator according to the present disclosure.

### DETAILED DESCRIPTION

Example implementations of the present disclosure include a robotic actuator, which, in some aspects, can be used with one or more robotic joints or other portions of a robotic system. A robotic system, according to the present disclosure can be or include a humanoid robot. A humanoid robot according to the present disclosure can be or include a full humanoid framework with bipedal lower body, upper body torso with two arm appendages, and a head appendage). Alternatively, a humanoid robot according to the present disclosure can include an upper body torso with two arm appendages and a head appendage, but with no bipedal lower body or a mobile platform attached to the upper body torso.

Example implementations of actuators of the present disclosure can include at least two planet gear sets (each with one or more planet gear), a sun gear (e.g., a single, centered sun gear), and at least two ring gears (e.g., one per planet gear set). In some aspects, the planet gears in one planet gear set have smaller diameters than the planet gears in another planet gear set. Thus, in such aspects, a ring gear engaged with the one planet gear set can have a smaller diameter with another ring gear engaged with the another planet gear set. Pairs of planet gears (one from each planet gear set) are coupled together and share a common center axis about which they rotate (e.g., spin).

In some cases, a gear ratio of more than 10:1 ratio is helpful, for example if higher torque output or less speed (for example, less rotational velocity) is required. A compound planetary gear set can be used to obtain an additional reduction factor (up to~25:1) with a stepped planet compound planetary gearbox configuration (SPCPGT) while still retaining the benefits of a Quasi Direct Drive (QDD) (e.g., benefits including low gear ratio actuation, such as 10:1 or less, with low inertia, low friction, etc.). Furthermore, implementations described herein can be easier to manufacture than the high precision gearboxes used in industrial robotics, making them a more suitable option for many robotics applications. In addition, implementations described herein provide for a modular design of a gearbox and robotic actuator (that includes the gearbox).

Being able to increase gear ratio beyond what a single stage planetary configuration provides can be beneficial for legged robotics applications (e.g., in humanoid robots with a humanoid lower body or humanoid lower body/humanoid torso). In legged locomotion, much of an actuator's torque goes towards inertial acceleration of the leg's own mass. In these situations, it is important to consider how power is transferred from the actuator to the leg inertia. It can be shown that matching the impedance of the leg to the impedance of the actuator's own inertia maximizes the power transfer between the actuator and the leg. Therefore, the SPCPGT configuration is useful to enable the gear ratio to be large enough to maximize power transfer while retaining benefits of QDD style actuation approaches specifically for legged robotics applications.

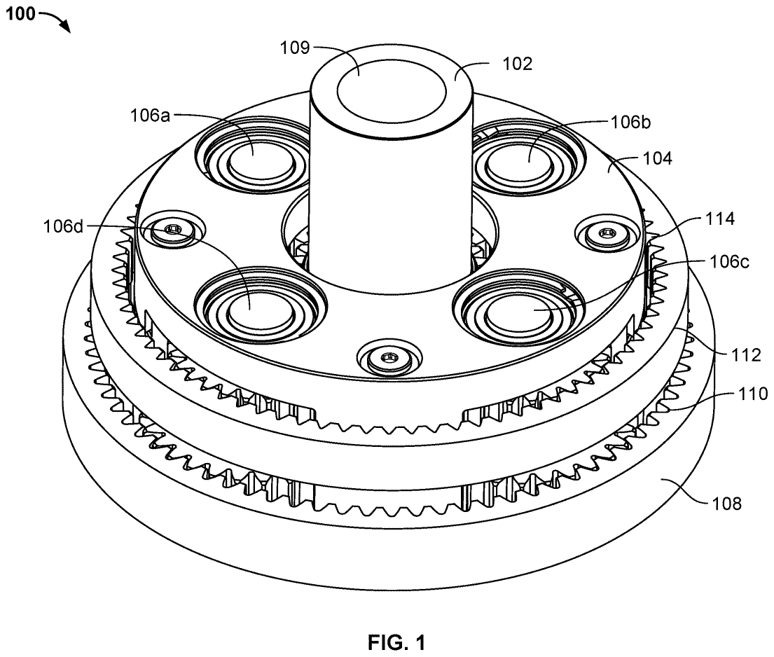

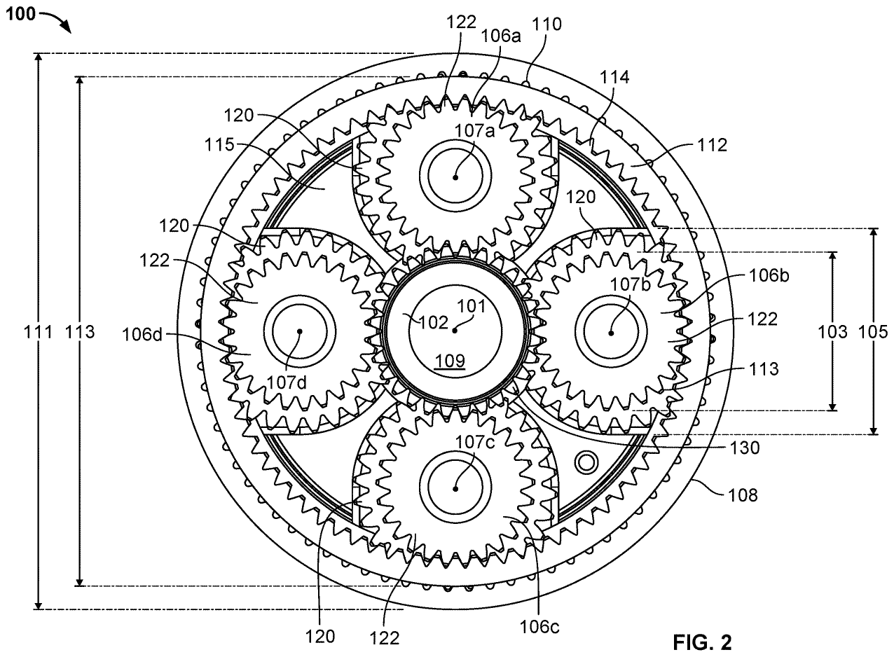

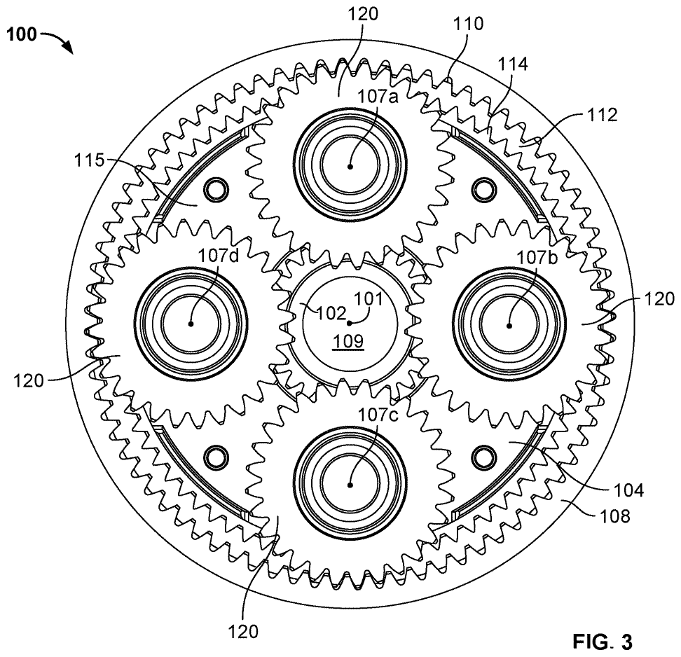

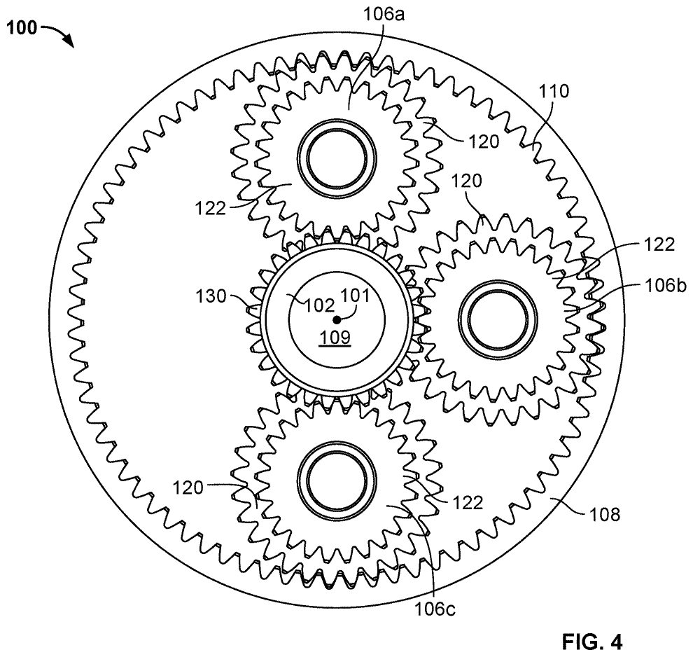

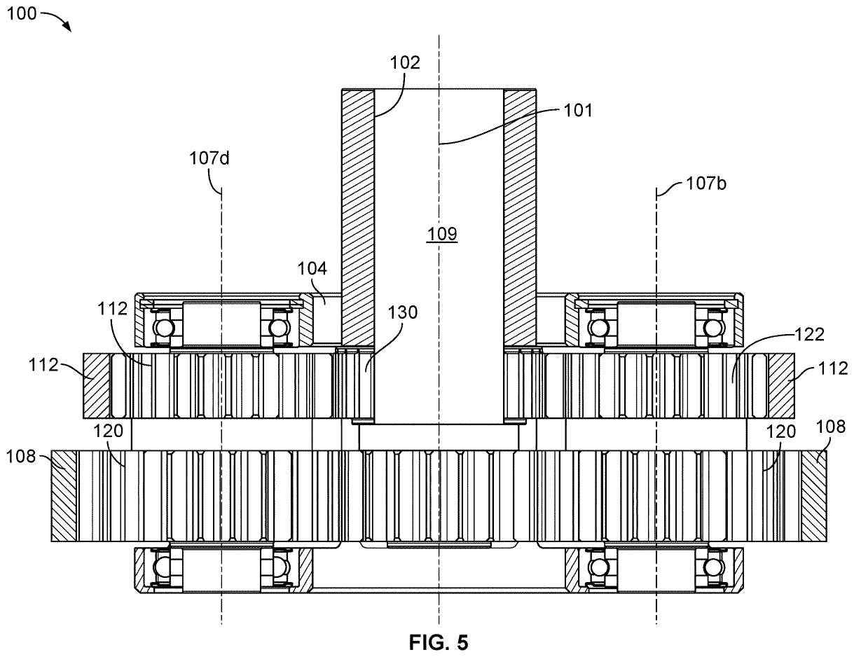

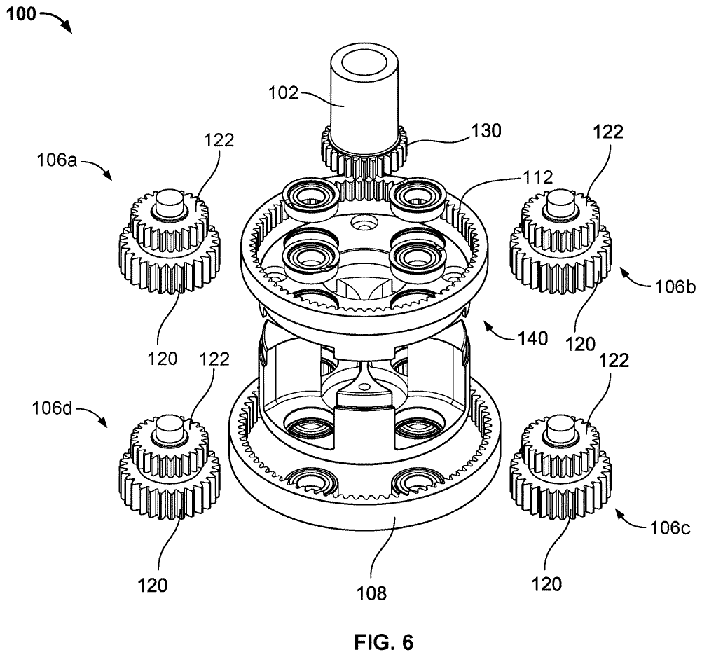

With reference to FIGS. 1-6, FIG. 1 is an isometric view of an example implementation of a gearbox assembly (or “gearbox”) 100 of a robotic actuator. FIG. 2 is a top down sectional view of the gearbox 100. FIG. 3 is bottom view of the gearbox assembly 100. FIG. 4 is a top down sectional view of the gearbox 100 with one or more components removed for clarity. FIG. 5 is a side sectional view of the gearbox 100. FIG. 6 is an exploded view of the gearbox 100 of FIGS. 1-5.

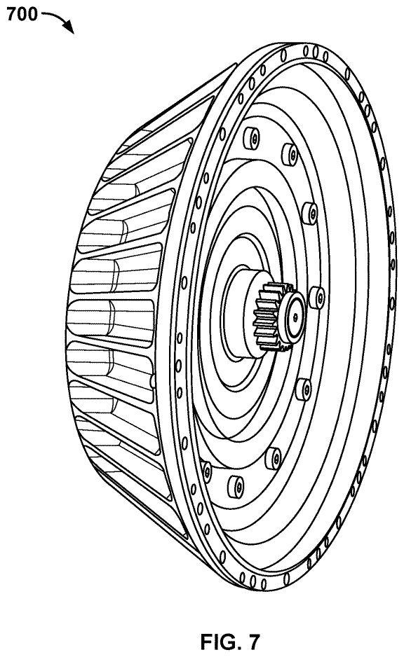

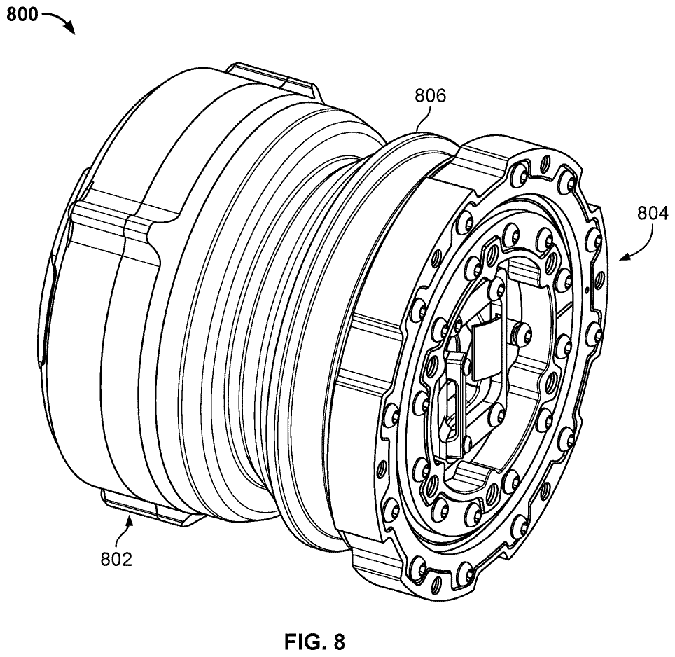

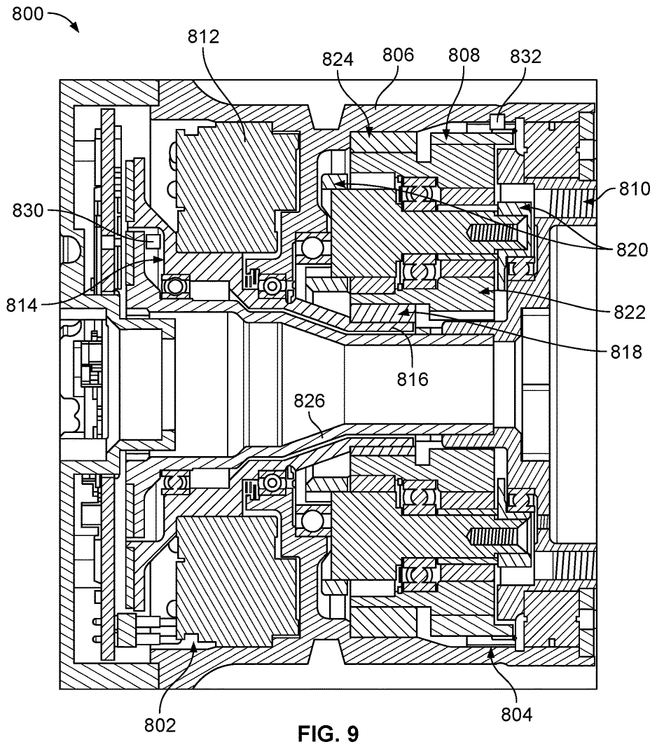

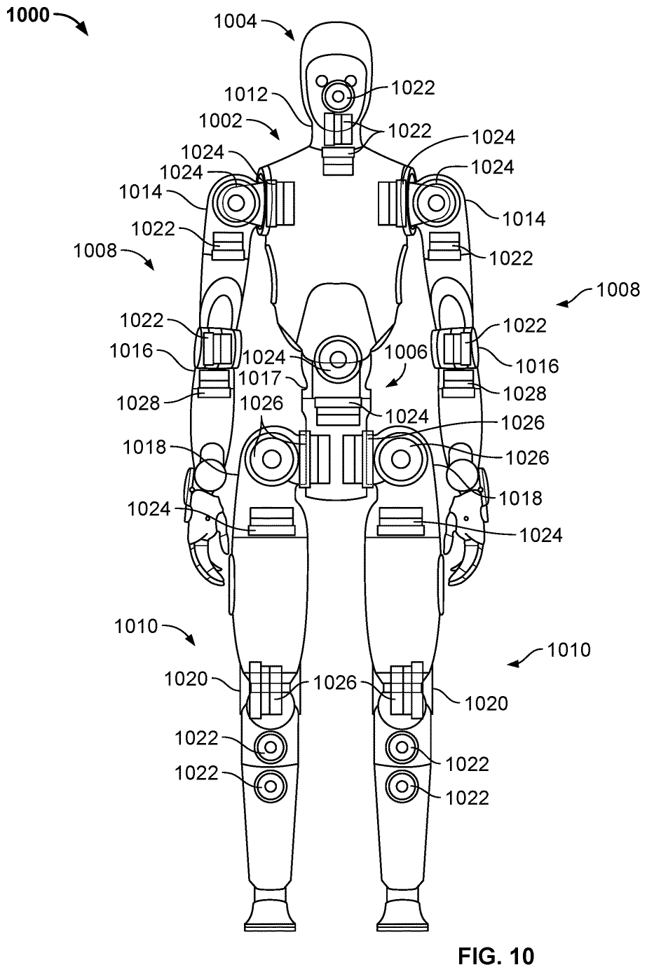

With reference to FIGS. 1-6, the illustrated example of the gearbox 100 includes a shaft 102 that is configured to couple to a motor (e.g., the motor 700 shown in FIG. 7, or the motor 802 shown in FIGS. 8 and 9) to form a robotic actuator (e.g., the robotic actuator 800 of FIGS. 8 and 9, and/or the robotic actuators shown in FIG. 10). The example gearbox 100 further includes a sun gear 130 (e.g., a single sun gear 130) that is rigidly coupled to the shaft 102. A planet carrier 104, as shown in certain figures, is part of a framework 140 that at least partially encloses multiple (in this example, four) planet gear pairs 106a-d.

In some implementations, the shaft 102 includes a hollow bore 109 extending through an entire longitudinal length of the shaft 102. The hollow bore 109 allows for the partial or complete passage of, e.g., wires, cables, tubing, and/or other components of a robotic actuator. For example, the hollow bore 109 of shaft 102 can be used as a wiring passage through the robotic actuator (and, therefore, through a joint of a humanoid robot that includes the robotic actuator).

In some instances where the example gearbox 100 connects to an electric motor to drive rotation of the shaft and is incorporated into a robotic actuator or similar system, the hollow bore 109 can extend through the entirety of the shaft 102, the electric motor, and the entirety of the robotic actuator to allow for passage of components (e.g., wiring, power cables, other cables, tubing, or other components) through the robotic actuator without impacting the operation of the robotic actuator or its components. For example, in an implementation where a gearbox is positioned at a joint of a humanoid robot, such as a hip, shoulder, or elbow, where it is desired to extend components, such as wiring, through the gearbox without exposing the components radially outward of the gearbox, the components can be routed through the hollow bore 109 and extend further past the gearbox to another component(s) of the humanoid robot. Optionally, a slip ring can be installed or positioned in the hollow bore 109 of the shaft 102 to allow for unlimited range of motion of the joint during operation of the robotic actuator.

As shown in FIGS. 1-6, each planet gear pair 106a-d includes a primary planet gear 120 and a secondary planet gear 122 that are coupled together (e.g., coaxially fixed) to rotate together about a common rotational axis 107a-d, respectively. For example, the coupled primary planet gear and secondary planet gear are coaxially aligned and rotationally fixed to each other to rotate together about their respective common rotational axis. Thus, this example of the gearbox 100 includes a primary set 115 of primary planet gears 120 and a secondary set 113 of secondary planet gears 122.

As shown in the figures, each primary planet gear 120 has a diameter 105 that is larger than a diameter 103 of each secondary planet gear 122. Therefore, in this example implementation, during operation of the gearbox 100, while the primary planet gear 120 and the secondary planet gear 122 in a particular planet gear pair 106a-d each spin or rotate together about the respective axis 107a-d at an equal or identical angular velocity, a linear speed (e.g., an instantaneous linear velocity) of the primary planet gear 120 at its geared surface is greater than a linear speed of the secondary planet gear 122 at its geared surface due to the difference in diameter 103 and 105 between the primary planet gear 120 and the secondary planet gear 122.

The illustrated implementation of the gearbox 100 includes a primary ring gear 108 with geared surface 110 and a secondary ring gear 112 with geared surface 114, where the geared surfaces 110, 114 are on radially inner surfaces of the respective ring gears 108, 112. As shown in the figures, the primary ring gear 108 engages the primary planet gears 120 during operation and thus spins or rotates at the same linear speed as the primary planet gears 120 at the point of contact between the primary planet gears 120 and the primary ring gear 108.

The secondary ring gear 112 engages the secondary planet gears 122 during operation and thus spins or rotates at the same linear speed as the secondary planet gears 122 at the point of contact between the secondary planet gears 122 and the secondary ring gear 112, but at a different linear speed than the primary ring gear 108. Each of the shaft 102, the sun gear 130, and the primary and secondary ring gears 108 and 112, respectively, spin or rotate about a common axis 101 during operation of the gearbox 100.

In this example, the sun gear 130 is engaged with the secondary planet gears 122 during operation of the gearbox 100. As a result, torque produced by a motor coupled to the shaft 102 results in rotation of the sun gear 130, which results in rotation of the secondary planet gears 122, which results in rotation of the primary planet gears 120 and the secondary ring gear 112, which results in rotation of the primary ring gear 108. The gearbox 100, in this example, includes four primary planet gears 120 and four secondary planet gears 122. However, other numbers of primary planet gears 120 and secondary planet gears 122 are within the scope of the present disclosure.

The example implementation of the gearbox 100 can operate with the following exemplary characteristics. For example, the gearbox 100 can have a gear ratio ranging between 10:1 and 100:1. A ratio of a power of a motor mechanically coupled to the gearbox 100 to a radial dimension of the gearbox 100 is between 1 root mean square (RMS) W/mm and 20 RMS W/mm. A ratio of an axial dimension of the gearbox 100 to the radial dimension of the gearbox 100 can range between 0.1 and 5.0. In some implementations, a radial dimension of the gearbox 100 corresponds to the radius of a front surface of a mechanical ground of an actuator that includes the gearbox 100, and the axial dimension of the gearbox 100 corresponds to the distance between a rear surface of the mechanical ground and a front surface of an output of the gearbox 100.

The backlash between the mechanical ground and an output of the gearbox 100 is between 6 arc minute and 50 arc minute. For example, the backlash between the mechanical ground and an output of the gearbox 100 can be the gear mesh backlash between the primary planet gear 120 and the primary ring gear 108. In some examples, the total backlash of the gearbox 100 can be an accumulation of all gear backlashes through the sun gear, planet gears, and ring gears.

In certain examples, the backlash between the mechanical ground and an output of the gearbox 100 can be the accumulation of gear mesh backlash between the sun gear 130 and a secondary planet gear 122, and between a primary planet gear 120 and the primary ring gear 108. In some implementations, the gearbox 100 is configured to generate a reflected inertia between 0.01 kg·m² and 1.00 kg·m².

FIG. 7 is a schematic illustration of an example implementation of a motor 700 for a robotic actuator that can include the example gearbox 100 of FIGS. 1-6. The example motor 700 is an electric motor, for example, having an electric stator and a rotor for rotation within the electric stator. The combination of the gearbox 100 and the motor 700 (rigidly coupled to the shaft 102 of the example gearbox 100) can form a robotic actuator according to the present disclosure.

Generally, such an actuator includes a mechanical ground that serves as the modular mechanical mounting interface of the actuator. The gearbox 100 of the actuator is mechanically coupled to the motor 700 by the motor stator that is affixed to the mechanical ground. The mechanical ground provides both mechanical fixturing as well as a thermal pathway to ambient for the motor 700. The rotor of the motor 700 is a permanent magnet rotor that produces torque due to interaction of the permanent magnets on the rotor with the magnetic field produced by the motor stator.

In some implementations, the permanent magnet rotor of the motor 700 is coupled to the shaft 102 of the gearbox 100, such that rotational output (e.g., rotation and torque) of the motor 700 is transmitted to the sun gear 130 via the shaft 102, and further transmitted through the gearbox 100 to the output of the gearbox 100 (e.g., to the primary ring gear 108).

In certain implementations, shaft 102 of the gearbox 100 is integral with the permanent magnet rotor of the motor 700. In some implementations, the motor 700 coupled to the gearbox 100 has a power rating ranging between 100 RMS Watts and 1000 RMS Watts. The motor 700 is described in more detail in International Patent Application PCT/US2023/062955, which is incorporated by reference herein in its entirety.

FIG. 8 is a perspective view of an example robotic actuator 800 according to the present disclosure, including a motor 802, gearbox 804, and a housing 806 to at least partially enclose the gearbox 804 and/or motor 802. FIG. 9 is a cross-sectional side view of the example robotic actuator 800 of FIG. 8. The motor 802 of the example robotic actuator 800 is similar to the motor 700 of FIG. 7, except that the motor 802 is shown as enclosed partially within the housing 806 and connected to the gearbox 804. The gearbox 804 of the example robotic actuator 800 is similar to the gearbox 100 of FIGS. 1-6, except that the gearbox 804 is shown as connected to the motor 802 via a shaft and/or rotor, the gearbox 804 is at least partially enclosed within the housing 806, and the primary ring gear 808 of the gearbox 804 is connected to an output 810 of the gearbox 804.

Referring to the example robotic actuator 800 of FIGS. 8 and 9, the housing 806 acts as the mechanical ground, serving as the modular mechanical mounting interface of the robotic actuator 800. The gearbox 804 of the robotic actuator 800 is mechanically coupled to the motor 802 by the motor stator 812 that is affixed to the housing 806 (the mechanical ground). The mechanical ground provides both mechanical fixturing as well as a thermal pathway to ambient for the motor 802. The rotor 814 of the motor 802 is a permanent magnet rotor that produces torque due to interaction of the permanent magnets on the rotor 814 with the magnetic field produced by the stator 812. In some implementations, the rotor 814 is coupled to the shaft of the gearbox 804, such that rotational output (e.g., rotation and torque) of the rotor 814 of the motor 802 is transmitted to the sun gear 818 of the gearbox 804, and further transmitted through the gearbox 804 to the output 810 of the gearbox 804 (e.g., via the primary ring gear 808). In certain implementations, the shaft of the gearbox 804 is integral with the rotor 814 of the motor 802.

The gearbox 804 of the example robotic actuator 800 includes a shaft 816 (similar to shaft 102) shown as integrally coupled to the rotor 814 of the motor 802, a sun gear 818 (similar to sun gear 130) that is rigidly coupled to the shaft 816, a planet carrier 820 (similar to planet carrier 104) that forms part of a framework that at least partially encloses multiple planet gear pairs 822 (similar to planet gear pairs 106a-d). The gearbox 804 also includes the primary ring gear 808 (similar to primary ring gear 108) with a geared surface and a secondary ring gear 824 (similar to secondary ring gear 112) with a geared surface, where the geared surfaces are on radially inner surfaces of the respective ring gears 808, 824. As shown in FIGS. 8-8, the primary ring gear 808 engages primary planet gears of the planet gear pairs 822 during operation, and the secondary ring gear 824 engages secondary planet gears of the planet gear pairs 822 during operation.

In the example robotic actuator 800, the secondary ring gear 824 is grounded, such that it is rotationally fixed relative to the mechanical ground or housing 806 and does not rotate. On the other hand, the primary ring gear 808 is able to rotate freely, for example, in response to turning movement and rotation of the primary plant gears of the planet gear pairs 822.

In this example robotic actuator, the sun gear 818 is engaged with the secondary planet gear portion of the planet gear pairs 822, and torque produced by the motor 802 that rotates the shaft 816 results in rotation of the sun gear 818, which results in rotation of the planet gear pairs 822. Rotation of the planet gear pairs 822 is constrained by the fixed structure of the secondary ring gear 824 since the secondary ring gear 824 is static, resulting in both rotation of the planet gear pairs 822 and turning of the planet carrier 820. This combination of turning and rotating of the planet gear pairs 822 causes rotation of the primary ring gear 808, which is rotationally connected to the actuator output 810. For example, driven rotation of the sun gear 818 by the motor 802 causes a resulting rotation of the gearbox output 810.

The shaft 816 includes a hollow bore extending through an entire longitudinal length of the shaft 816, for example, entirely through the motor 802, gearbox 804, and output 810 of the gearbox 804. In some instances, such as in the example robotic actuator 800, a support shaft 826 is disposed radially inward of the shaft 816 and acts as a static shield for the hollow bore from rotation of the rotor 814 and/or shaft 816. The hollow bore allows for the partial or complete passage of, e.g., wires, cables, tubing, and/or other components through the robotic actuator 800, and in some instances, the support shaft 826 provides a protected tubing passageway for these components through the motor 802 and gearbox 804.

For example, the hollow bore of shaft 816 can be used as a wiring passage through the robotic actuator 800 (and, therefore, through a joint of a humanoid robot that includes the robotic actuator 800). In some instances, the hollow bore extends through the entirety of the shaft 816, the electric motor 802, and the entirety of the robotic actuator 800 to allow for passage of components (e.g., wiring, power cables, other cables, tubing, or other components) through the robotic actuator 800 without impacting the operation of the robotic actuator 800 or its components. For example, in an implementation where the actuator 800 is positioned at a joint of a humanoid robot (e.g., as depicted in FIG. 10), such as a hip, shoulder, or elbow, where it is desired to extend components, such as wiring, through the actuator 800 without exposing the components radially outward of the actuator 800, the components can be routed through the hollow bore and extend further past the actuator 800 to another component(s) of the humanoid robot. In some examples, a slip ring can be installed or positioned in the hollow bore of the shaft 102 to allow for unlimited range of motion of the joint during operation of the robotic actuator 800.

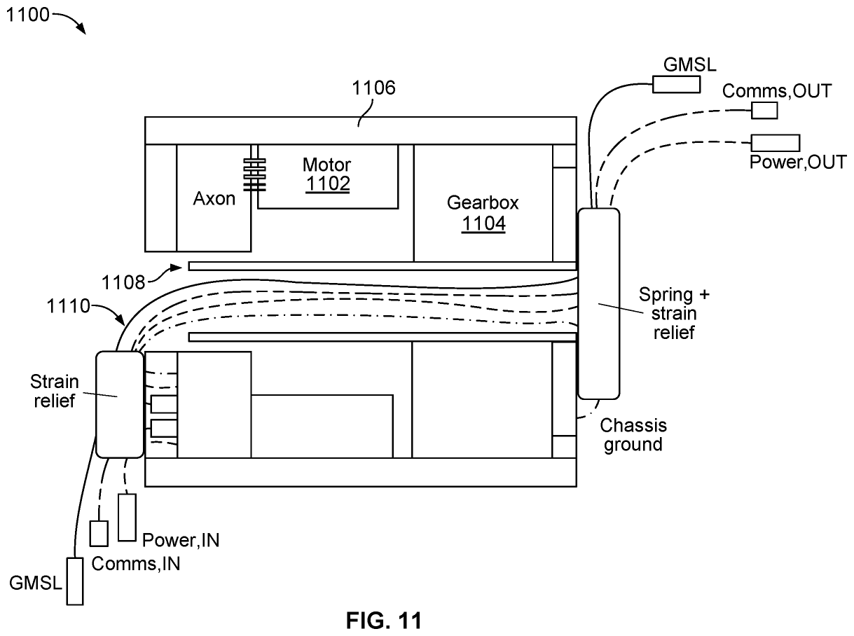

Turning to FIG. 11, this figure shows a schematic, cross-sectional side view of an example robotic actuator 1100 according to the present disclosure that can incorporate some or all of the features of the example robotic actuator 800 of FIGS. 8 and 9, such as the motor 1102, gearbox 1104, and housing 1106. The example robotic actuator 1100 includes a hollow bore 1108 that allows for the passage of wire components 1110 through the bore 1108. The wire components 1110 can include power, communications, ground wire, gigabit multimedia serial link (GMSL) or other cable, and/or other components.

In an example implementation, the robotic actuator 800 of FIGS. 8 and 9, formed of the motor 802 and gearbox 804, can include two magnetic sensors: a motor commutation sensor 830 and an output position measurement sensor 832. A variety of sensor types may be used for the commutation sensor and output position sensor. A magnetic incremental rotary encoder can be used for the commutation sensor 830. For example, a ring magnet can be mounted to the rotor 814 of the motor 802 or other portions of the motor 802 such that the ring magnet rotates with the rotor 814. The commutation sensor 830 can include a read head that is fixed relative to the mechanical ground (housing 806). The read head of the commutation sensor 830 detects the magnetic field of the ring magnet of the commutation sensor 830. The read head of the commutation sensor 830 can output a signal indicative of the angular displacement of the ring magnet of the commutation sensor 830, which indicates the position of the rotor 814 relative to the mechanical ground.

In example aspects, an output position sensor 832 can be a magnet that is coupled to and rotates with the output 810 of the gearbox 804 and actuator 800. For example, the output position sensor 832 can determine a position of the output 832 during operation. In some examples, a center shaft can be fixed to the actuator output and the magnet of the output position sensor 832 is mounted at the end of the center shaft distal from the actuator output. As the actuator output rotates, the center shaft and, hence, magnet of the output position sensor 832 also rotates. A read head of the actuator output position sensor 832 is fixed relative to the mechanical ground and positioned to detect the output of the magnetic field generated by the magnet of the output position sensor 832. The read head of the output position sensor 832 outputs a signal indicative of the angular displacement of the magnet of the output position sensor 832, and hence the angular displacement of the actuator output 810, relative to the mechanical ground. In some aspects, the planet carrier 820 can be connected back to the mechanical ground (e.g., via the housing 806) of the actuator 800 through a supporting bearing. For example, the mechanical ground provides grounded support for the planet carrier 104 along the common rotational axis, while the supporting bearing allows for rotation of the planet carrier 104 about the common rotational axis. The supporting bearing can include a roller bearing, ball bearing, plain bearing, another bearing type, or a combination of these bearings.

In some implementations, the example robotic actuator 800 or other actuator can be radially stacked in that one or more of the motor 802, the gearbox 804, or the actuator output 810 are circumferentially contained within the actuator's mechanical ground. In some aspects, the motor 802, the gearbox 804, and the planet carrier 820 can be circumferentially within the housing 806, or mechanical ground, of the actuator 800.

FIG. 10 is a schematic illustration of a humanoid robot 1000 that includes at least one robotic actuator according to the present disclosure. As shown in this example, humanoid robot 1000 includes a torso 1002 to which a head 1004 and one or more torso appendages 1008 (e.g., arms 1008) are coupled. A trunk 1006 is coupled to the torso 1002, with one or more lower body appendages 1010 (e.g., legs 1010) coupled to the trunk 1006 to form the humanoid robot 1000. In alternative aspects, other forms of lower body appendages, such as a mobile base with wheels, can be coupled to the trunk 1006 rather than legs 1010. As another alternative example, the torso 1002 (with torso appendages 1008 and head 1004) can be mounted on a stationary or mobile base exclusive of the trunk 1006 and lower body appendages 1010.

The aforementioned components of the humanoid robot 1000 can be coupled together at joints which are formed (at least partially) by robotic actuators according to the present disclosure. For example, neck joint 1012 couples the head 1004 of the humanoid robot 1000 to the torso 1002. Shoulder joints 1014 couple the torso appendages 1008 to the torso 1002. Within the torso appendages 1008, elbow joints 1016 are positioned to couple, for example, an upper arm portion of the appendage 1008 to a lower arm portion (e.g., wrist, and end effector) of the appendage 1008.

A torso joint 1017 (or waist joint 1017) couples the torso 1002 to the trunk 1006. Hip joints 1018 couple the trunk 1006 to the lower body appendages 1010. Within the lower body appendages 1010, knee joints 1020 are positioned to couple, for example, an upper leg portion of the appendage 1010 to a lower leg portion (e.g., ankle and foot) of the appendage 1010.

In this example implementation of the humanoid robot 1000, each of the aforementioned joints can be comprised of a single or multiple robotic actuator that facilitates one or multiple degrees of freedom (DOF) of movement of the particular appendages 1008 and 1010, as well as the overall components of the torso 1002, head 1004, and trunk 1006 of the humanoid robot 1000. As the particular joints 1012, 1014, 1016, 1017, 1018, and 1020, as well as appendages 1008 and 1010, can have different functional and performance requirement, the illustrated robotic actuators can have different outputs (e.g., torque, gear ratio, and other performance characteristics) to provide for the unique functional and performance requirements for each joint or appendage.

As shown in this example of the humanoid robot 1000, there can be four different robotic actuators: robotic actuator 1022, robotic actuator 1024, robotic actuator 1026, and robotic actuator 1028. Each robotic actuator 1022, 1024, 1026, and 1028, in this example, can be formed with a motor and gearbox as previously described to form the actuator. In this example, three robotic actuators 1022 operate in combination to operate the neck joint 1012. Two robotic actuators 1024 and one robotic actuator 1022 operate in combination to operate each shoulder joint 1014. One robotic actuator 1022 and one robotic actuator 1028 operate in combination to operate each elbow joint 1016. Two robotic actuators 1024 operate in combination to operate the torso joint 1017. Two robotic actuators 1026 operate in combination to operate each hip joint 1018. The lower body appendages 1010 are operated with a combination of robotic actuators, including a robotic actuator 1026 to operate each knee joint 1020, as well as two robotic actuators 1022 and one robotic actuator 1024 to operate each lower body appendage 1010.

In some examples, the DOFs of robotic actuator 1022 can include neck yaw, neck pitch, and neck roll, internal and/or external rotation of the shoulder, flexion and/or extension of the elbow, pitch and/or roll of the ankle, or a combination of these movements. In some examples, the DOFs of robotic actuator 1024 can include flexion and/or extension of the shoulder, abduction and/or adduction of the shoulder, yaw and/or roll of the torso, internal and/or external rotation of the hip, or a combination of these movements. In some example, the DOFs of robotic actuator 1026 can include flexion and/or extension of the hip, abduction and/or adduction of the hip, flexion and/or extension of the knee, or a combination of these movements.

As described, the illustrated robotic actuators can have different performance characteristics (e.g., rotational output) tailored to the unique functional and performance requirements for each joint or appendage. In the example implementation of the humanoid robot 1000, certain of the robotic actuators can have an increased torque/lower speed relative to other of the robotic actuators. For example, robotic actuators 1026 (used primarily as lower body actuators) can have a higher torque output and lower speed output as compared to robotic actuators 1022, 1024, and 1028. Robotic actuators 1024 (used in shoulders, trunk, and upper leg) can have a higher torque output and lower speed output as compared to robotic actuators 1022 and 1028. In some aspects, robotic actuators 1022 (used in neck, elbows, and lower leg) can have a higher torque output and lower speed output as compared to robotic actuator 1028 (used in wrist).

A number of implementations have been described. Nevertheless, it will be understood that various modifications can be made without departing from the spirit and scope of the disclosure. For example, example operations, methods, or processes described herein can include more steps or fewer steps than those described. Further, the steps in such example operations, methods, or processes can be performed in different successions than that described or illustrated in the figures. Accordingly, other implementations are within the scope of the following claims.

1. A robotic actuator, comprising:
a mechanical ground;
a motor coupled to the mechanical ground, the motor comprising a stator and a rotor;
a gearbox, comprising:
a shaft that extends through the gearbox and comprises a hollow bore;
a first plurality of first planet gears;
at least one sun gear that rides on the shaft and is rotationally coupled to the rotor, the at least one sun gear configured to transmit torque produced by the rotor of the motor to the first planet gears;
a second plurality of second planet gears;
a first ring gear coupled to the first planet gears; and
a second ring gear coupled to the second planet gears; and
an actuator output coupled to an output of the gearbox.

2. The robotic actuator of claim 1, wherein the hollow bore extends through an entire longitudinal length of the shaft, and is adapted to provide passage of a wire component at least partially through the robotic actuator.

3. (canceled)

4. The robotic actuator of claim 1, wherein the shaft comprises a slip ring disposed in the hollow bore and configured to transmit power or signal to the robotic actuator.

5. The robotic actuator of claim 1, comprising a support shaft disposed at least partially within the hollow bore of the shaft of the gearbox and coupled to the mechanical ground, the support shaft having a second hollow bore extending at least partially through the shaft of the gearbox.

6. (canceled)

7. The robotic actuator of claim 5, wherein the support shaft is fixedly mounted to the mechanical ground, and coupled to the shaft of the gearbox with at least one bearing.

8. (canceled)

9. (canceled)

10. (canceled)

11. (canceled)

12. (canceled)

13. (canceled)

14. (canceled)

15. The robotic actuator of claim 1, wherein the first ring gear comprises a first diameter, and the second ring gear comprises a second diameter larger than the first diameter.

16. (canceled)

17. The robotic actuator of claim 1, wherein the gearbox has a gear ratio between 10:1 and 100:1.

18. The robotic actuator of claim 1, wherein a ratio of a power of the motor to a radial dimension of the robotic actuator is between 1 RMS Watts/mm to 20 RMS Watts/mm.

19. (canceled)

20. (canceled)

21. The robotic actuator of claim 1, wherein the robotic actuator is configured to generate an amount of torque between 20 RMS Nm and 200 RMS Nm, and a backlash between the mechanical ground and the actuator output is between 6 arc minute and 50 arc minute.

22. (canceled)

23. (canceled)

24. (canceled)

25. (canceled)

26. The robotic actuator of claim 1, wherein at least one of the motor or the gearbox is circumferentially surrounded by the mechanical ground.

27. The robotic actuator of claim 1, comprising:
a planet carrier coupled to the mechanical ground and configured to support the first planet gears and the second planet gears, the planet carrier coupled to the mechanical ground by at least one bearing, and wherein the motor, gearbox and planet carrier are circumferentially surrounded by the mechanical ground.

28. (canceled)

29. (canceled)

30. (canceled)

31. The robotic actuator of claim 1, comprising a sensor configured to detect commutation of the motor, the sensor comprising an incremental rotary encoder, the sensor comprising:
a ring magnet mounted to the motor; and
a read head coupled to the mechanical ground and configured to detect a magnetic field generated by the ring magnet.

32. (canceled)

33. (canceled)

34. The robotic actuator of claim 31, comprising a second sensor configured to detect an amount of output of the robotic actuator, the second sensor comprising:
a second magnet coupled to the actuator output; and
a second read head coupled to the mechanical ground and configured to detect a magnetic field generated by the second magnet.

35. (canceled)

36. The robotic actuator of claim 34, wherein the second read head generates a signal indicating angular displacement of the second magnet relative to the mechanical ground.

37. (canceled)

38. (canceled)

39. A humanoid robot, comprising:
at least one robotic limb; and
an actuator configured to move at least a portion of the at least one robotic limb, the actuator comprising:
a mechanical ground;
a motor coupled to the mechanical ground, the motor comprising a stator and a rotor;
a gearbox, comprising:
a shaft that extends through the gearbox and comprises a hollow bore;
a first plurality of first planet gears;
at least one sun gear that rides on the shaft and is rotationally coupled to the rotor, the at least one sun gear configured to transmit torque produced by the rotor to the first planet gears;
a second plurality of second planet gears;
a first ring gear coupled to the first planet gears; and
a second ring gear coupled to the second planet gears; and
an actuator output coupled to an output of the gearbox.

40. The humanoid robot of claim 39, wherein the hollow bore extends through an entire longitudinal length of the shaft, and the hollow bore is adapted to provide passage of a wire component at least partially through the robotic actuator.

41. (canceled)

42. The humanoid robot of claim 39, wherein the shaft comprises a slip ring disposed in the hollow bore and configured to transmit power or signal to the robotic actuator.

43. The humanoid robot of claim 39, comprising a support shaft disposed at least partially within the hollow bore of the shaft of the gearbox and coupled to the mechanical ground, the support shaft having a second hollow bore extending at least partially through the shaft of the gearbox.

44. (canceled)

45. The humanoid robot of claim 44, wherein the support shaft is fixedly mounted to the mechanical ground and coupled to the shaft of the gearbox with at least one bearing.

46. (canceled)

47. (canceled)

48. (canceled)

49. (canceled)

50. (canceled)

51. (canceled)

52. (canceled)

53. The humanoid robot of claim 39, wherein the first ring gear comprises a first diameter, and the second ring gear comprises a second diameter larger than the first diameter.

54. (canceled)

55. The humanoid robot of claim 39, wherein the at least one robotic limb is a robotic leg.

56. The humanoid robot of claim 55, wherein:
the humanoid robot comprises a hip joint assembly; and
the actuator is configured to adjust the respective hip joint assembly in two degrees of hip freedom through differential linear actuation.

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. The humanoid robot of claim 39, comprising a sensor configured to detect commutation of the motor, the sensor comprising an incremental rotary encoder, the sensor comprising:
a ring magnet mounted to the motor; and
a read head coupled to the mechanical ground and configured to detect a magnetic field generated by the ring magnet.

71. (canceled)

72. (canceled)

73. The humanoid robot of claim 70, comprising a second sensor configured to detect an amount of output of the actuator, the second sensor comprising:
a second magnet coupled to the actuator output; and
a second read head coupled to the mechanical ground and configured to detect a magnetic field generated by the second magnet, the second read head configured to generate a signal indicating angular displacement of the second magnet relative to the mechanical ground.

74. (canceled)

75. (canceled)

76. The humanoid robot of claim 39, wherein the output of the gearbox comprises the second ring gear, and the actuator output is rotationally fixed to the second ring gear.

77. (canceled)

78. The humanoid robot of claim 39, wherein the actuator is one of a plurality of actuators.

79. The humanoid robot of claim 78, comprising a trunk, at least one upper body appendage comprising the at least one robotic limb, and at least one lower body appendage, wherein each appendage of the at least one upper body appendage and the at least one lower body appendage comprises a respective actuator of the plurality of actuators.

80. The humanoid robot of claim 79, comprising:
a torso joint coupling a torso of the humanoid robot to the trunk, the torso joint comprising a torso actuator of the plurality of actuators;
a first hip joint coupling the trunk to a first lower body appendage of the at least one lower body appendage, the first hip joint comprising a first hip actuator of the plurality of actuators; and
a second hip joint coupling the trunk to a second lower body appendage of the at least one lower body appendage, the second hip joint comprising a second hip actuator of the plurality of actuators.

81. (canceled)

82. The humanoid robot of claim 80, comprising:
a first knee joint coupling a first upper portion of the first lower body appendage to a first lower portion of the first lower body appendage, the first knee joint comprising a first knee actuator of the plurality of actuators; and
a second knee joint coupling a second upper portion of the second lower body appendage to a second lower portion of the second lower body appendage, the second knee joint comprising a second knee actuator of the plurality of actuators.

83. The humanoid robot of claim 80, comprising:
a first shoulder joint coupling the trunk to a first upper body appendage of the at least one upper body appendage, the first shoulder joint comprising a first shoulder actuator of the plurality of actuators;
a second shoulder joint coupling the trunk to a second upper body appendage of the at least one upper body appendage, the second shoulder joint comprising a second shoulder actuator of the plurality of actuators;
a first elbow joint coupling a first upper portion of the first upper body appendage to a first lower portion of the first upper body appendage, the first elbow joint comprising a first elbow actuator of the plurality of actuators; and
a second elbow joint coupling a second upper portion of the second upper body appendage to a second lower portion of the second upper body appendage, the second elbow joint comprising a second elbow actuator of the plurality of actuators.

84. (canceled)

85. The humanoid robot of claim 79, comprising a plurality of joints supporting the trunk, the at least one upper body appendage, and the at least one lower body appendage, wherein the plurality of actuators include actuators of varying sizes, and each joint of the plurality of joints comprises at least one actuator of the plurality of actuators.

86. The humanoid robot of claim 85, wherein at least one joint of the plurality of joints comprises a first actuator and a second actuator of the plurality of actuators.

87. The humanoid robot of claim 86, wherein the first actuator and the second actuator are different.
